(19) United States
(12) Patent Application Publication
(10) Pub. No.: US 2013/0040124 A1
(43) Pub. Date: Feb. 14, 2013

(54) METHOD FOR PREPARING TRANSPARENT ANTISTATIC FILMS USING GRAPHENE AND TRANSPARENT ANTISTATIC FILMS PREPARED BY THE SAME

(71) Applicants: Chong Min Koo, Gyeonggi-do (KR); Soon Man Hong, Seoul (KR); Seung Sang Hwang, Seoul (KR); Soon Jong Kwak, Seoul (KR); Kyung Youl Baek, Seoul (KR); Kyung Ho Min, Chungcheongbuk-do (KR); Youn Duk Park, Seoul (KR); Hee La Kwak, Seoul (KR); Myung Hee Kim, Seoul (KR); Bo Ri Kim, Seoul (KR); Seung Sock Choi, Gyeongsangbuk-do (KR); Tae Hee Han, Daejeon (KR)

(72) Inventors: Chong Min Koo, Gyeonggi-do (KR); Soon Man Hong, Seoul (KR); Seung Sang Hwang, Seoul (KR); Soon Jong Kwak, Seoul (KR); Kyung Youl Baek, Seoul (KR); Kyung Ho Min, Chungcheongbuk-do (KR); Youn Duk Park, Seoul (KR); Hee La Kwak, Seoul (KR); Myung Hee Kim, Seoul (KR); Bo Ri Kim, Seoul (KR); Seung Sock Choi, Gyeongsangbuk-do (KR); Tae Hee Han, Daejeon (KR)

(73) Assignee: KOREA INSTITUTE OF SCIENCE AND TECHNOLOGY, Seoul (KR)

(21) Appl. No.: 13/643,759

(22) PCT Filed: Apr. 5, 2011
(86) PCT No.: PCT/KR2011/002350

§ 371 Date: Oct. 26, 2012

(30) Foreign Application Priority Data
Apr. 27, 2010 (KR) 10-2010-0039009

(51) Int. Cl. B05D 5/12; B32B 5/16; B82Y 30/00; B82Y 40/00

(52) U.S. Cl. 428/220; 428/323; 427/122; 427/521; 977/734; 977/753

(57) ABSTRACT

The present invention relates to transparent antistatic films using graphene, and methods for preparing the same. The films include conductive particles comprising a single-layer or multi-layer graphene, and a binder. The films are prepared by dispersing graphene in a solvent to obtain a graphene dispersion; dissolving a curable binder to a solvent to obtain a binder solution; mixing the graphene dispersion, the binder solution and optionally an additive to obtain a coating solution; applying the coating solution onto a substrate and drying the solution to form a coated film; and curing the coated film. According to the present invention, transparent or semitransparent antistatic films having excellent permeability, abrasion resistance, scratch resistance, chemical stability and dimensional stability can be prepared. The films also have superior adhesion to substrates and applicability, and thus may be advantageously applied to rigid or flexible substrates.

### TECHNICAL FIELD

The present invention relates to transparent antistatic films, more specifically methods for preparing transparent or semitransparent antistatic films comprising a conductive filler in a nano graphite sheet form where single-layer or multi-layer graphene layers are laminated; and a thermocurable or photocurable binder such as a silicone-based binder or an organic binder, and transparent or semitransparent antistatic films prepared by the same.

### BACKGROUND ART

As technologies of miniaturization, integration and microfabrication for office automation (OA) equipment and electronic equipment become advanced, there has been an increasing demand each year by the industry for reducing the adhesion of dust particles on electrical/electronic parts. For example, these needs are noticeably increasing in the field of IC chips that are being used in internal parts of semiconductor devices, wafers, computer hard discs, where the adhesion of dust particles on those parts should be completely prevented by imparting antistaticity to them.

In particular, for semiconductor processes requiring super high precision, there is a noticeable increase in failure occurrence caused by dust or static electricity. Therefore, when delivering manufactured semiconductor chips, in order to prevent possible damage caused by static electricity, antistatically treated carriers (referred to as shipping trays) are used or they are delivered in a roll form using antistatically treated carrier tapes. Further, in cleanrooms where ultrafine patterns of semiconductor devices are formed, the number of fine dust particles has a great effect on process yields and can be decreased by antistatically coating the cleanroom. In addition, for liquid crystal display (LCD) devices, damage to sensitive parts such as liquid crystal cells that is caused by static electricity is prevented by antistatically coating the protective films of the polarizing plate. Further, for various other electronics, automobiles, construction materials, cosmetics, wooden materials and the like, there has been an increasing demand for antistatic films in various forms in order to prevent contamination and secondary damage caused by static electricity.

In application fields where transparency is not required, antistatically coating may be performed by mixing conductive powders, such as metal powder and carbon black, with synthetic resins to obtain a coating solution, and coating the obtained solution on a substrate, as disclosed in Japanese Laid-Open Publication No. 2000-015753 and Japanese Laid-Open Publication No. (Sho)58-91777. However, for applications in display devices or optical devices requiring transparency, there are limited conductive materials that can be used.

Japanese Laid-Open Publication No. (Hei)5-109132 discloses imparting antistaticity to antistatic hard coatings used for optical discs by using lithium (Li) salts. However, this technology is problematic in that lithium or lithium-containing inorganics are likely to be released, the durability is likely to be lowered by chlorination, and the resistance of antistatic coated layer is as high as 10¹³Ω/□. In addition, Japanese Laid-Open Publication No. 2002-060736 discloses antistatic films that are obtained by mixing a polythiophene-based conductive polymer, a water soluble compound having an amide bond or hydroxy group, and an aqueous dispersion of self-emulsifiable polyester resin to obtain a dispersion, and coating the obtained dispersion on a substrate. Further, Korean Laid-Open Publication Nos. 10-2007-0087852 and 10-2007-0093936 disclose antistatic films using a coating solution where a photocurable acrylic binder or a low molecular weight organic acid compound are mixed with a polythiophene-based conductive polymer. Recently, Korean Laid-Open Publication No. 10-2009-0032604 discloses preparing antistatic films by mixing conductive particles of single-walled carbon nanotubes with silane-based compounds to obtain a dispersion, and coating the obtained dispersion on a substrate. However, dispersions of polythiophene-based conductive polymer or single-walled carbon nanotubes are very expensive materials, and thus, there is a desperate need for manufacturing antistatic films by using low cost materials.

### DISCLOSURE OF INVENTION

### Technical Problem

Therefore, it is an object of the present invention to provide an economical method for preparing transparent or semitransparent antistatic films with excellent abrasion resistance, scratch resistance, chemical stability, dimensional stability, adhesion to substrates, flexibility, hardness, etc., and transparent or semitransparent antistatic films prepared by the same.

### Technical Solution

The present inventors have endeavored to achieve the above object, and arrived at the present invention by discovering that the above object can be achieved by using conductive particles in a sheet form where single-layer or multi-layer graphene obtained from inexpensive graphite by physical or chemical separation process is laminated, and a polymer binder.

### Advantageous Effects

According to the present invention, transparent or semitransparent antistatic films having excellent abrasion resistance, scratch resistance, chemical stability, dimensional stability, adhesion to substrates, flexibility, hardness, etc., can be prepared with a low cost by using a conductive material that is a nano-graphite sheet where single-layer or multi-layer graphenes obtained from graphites by physical or chemical separation processes are laminated, and a silicone-based binder or an organic binder.

### DESCRIPTION OF DRAWINGS

FIGS. 1(A)-(B) are (A) an atomic force microscopy (AFM) image and (B) results from an AFM analysis of graphene coated on a silicone wafer.

FIG. 2 is a scanning electron microscope (SEM) image of the antistatic film obtained by using graphene that is coated on a polycarbonate (PC) film.

### BEST MODE FOR CARRYING OUT THE INVENTION

The present invention relates to transparent or semitransparent antistatic films comprising conductive particles including single-layer or multi-layer, specifically 30- or less layer graphene, and a binder, and the conductive particles specifically comprise nanometer scale graphite particles in a sheet form.

As for the graphenes, those prepared by any method may be used, but it is desirable to use graphenes that are separated from graphite by supercritical processes [Pu, N. W. et al, Materials Letters, 63, 1987 (2009)], ultrasonic processes or physical processes, or graphenes that are obtained by subjecting graphite to oxidation under chemically strong oxidation conditions, such as the Hummers process [Hummers, W. S., Offeman, R. E., J. Am. Chem. Soc. 80, 1339 (1958)], and then to a treatment with reducing agents having strong reduction potentials, such as hydrazine [Stankovich, S. et al, Nature, 442, 282 (2006)]. More specifically, the ratio of oxygen atoms in the graphene molecule is 30% or less, specifically 25% or less, most specifically 20% or less. If the ratio of oxygen atoms in the graphene molecule is greater than 30%, the electrical conductivity is lowered, thereby exhibiting no antistaticity.

Antistatic films of the present invention have a surface resistivity ranging from 10² to 10¹³Ω/□, specifically from 10⁴ to 10⁸Ω/□. When the surface resistivity is greater than 10¹³Ω/□, the electrical conductivity is lowered, thereby exhibiting no antistaticity. Further, the antistatic films typically have a thickness ranging from 0.003 μm to 1000 μm, specifically from 0.01 to 10 μm, most specifically from 0.05 to 1 μm, and a transparency ranging from 30% to 99.9%, specifically from 70% to 99.9%, as measured at a wavelength of 550 nm. Antistatic films that are too thin are problematic in that their coating stabilities are reduced, whereas films that are too thick have problems in terms of the unnecessary loss of coating solution therefor. Further, films having transparency of less than 30% is problematic in that they cannot be used in transparent or semitransparent applications.

The present invention also relates to methods for preparing antistatic films, where the methods involve:

dispersing graphene in a solvent to obtain a graphene dispersion;

dissolving a curable binder in a solvent to obtain a binder solution;

mixing the graphene dispersion, the binder solution and optionally an additive to obtain a coating solution;

applying the coating solution to a substrate and drying the solution to form a coated film; and

curing the coated film.

In one embodiment of the present invention, the substrate may be at least one selected from the group consisting of glass, silicone wafer, ceramic and plastic, and the coating may be carried out by spray coating, spin coating, dip coating, screen coating, inkjet coating, gravure coating, knife coating, kiss coating, stamping, imprint and the like. Further, it is desirable that the curing is carried out by thermal or ultraviolet curing processes.

For solvents used in the dispersion step and dissolving step, it is desirable to use one or more selected from the group consisting of, but not limited to, methyl alcohol, ethyl alcohol, isopropyl alcohol, butyl alcohol, acetone, methyl ethyl ketone, ethylene glycol, tetrahydrofuran, dimethylformamide, dimethylacetamide, N-methyl-2-pyrrolidone, hexane, cyclohexane, cyclohexanone, toluene, xylene, cresol, chloroform, distilled water, dichlorobenzene, dimethylbenzene, trimethylbenzene, pyridine, methylnaphthalene, nitromethane, acrylonitrile, methylene chloride, octadecylamine, aniline, dimethyl sulfoxide and benzyl alcohol.

In a specific embodiment of the present invention, the curable binder may be a thermocurable or photocurable binder, more specifically a silicone-based binder or an organic binder.

Specifically, examples of the silicone-based binder include alkoxy silane monomers having a pendant functional group, that are represented by Formula 1, Formula 2 or Formula 3 below, and silicone-based binders having a number average molecular weight of 300 to 3,000,000 g/mol that are prepared from said silane monomers by using acid or alkali catalysts. However, other silicone-based binders that are typically used in the art may also be used.

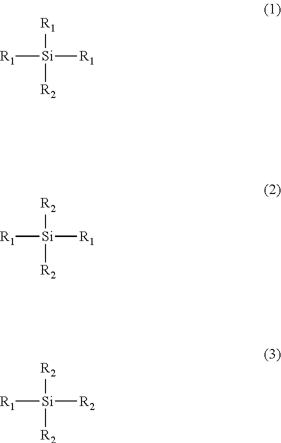

wherein,

R₁ is an alkoxy group; and

R₂ is independently selected from organic functional groups such as, but not limited to a C₁-C₁₂ alkyl, C₁-C₁₂ aryl, C₁-C₁₂ vinyl, C₁-C₁₂ amine, C₁-C₁₂ acryl, C₁-C₁₂ alkylhalogen, C₁-C₁₂ aldehyde, C₁-C₁₂ ketone, C₁-C₁₂ ester, C₁-C₁₂ amide, C₁-C₁₂ carboxylic acid and halogen group.

The organic binder may be a polymer having a number average molecular weight of 100 to 10,000,000 g/mol that comprises a C₁-C₁₂ alkyl, C₁-C₁₂ aryl, C₁-C₁₂ vinyl, C₁-C₁₂ amine, C₁-C₁₂ acryl, C₁-C₁₂ alkylhalogen, C₁-C₁₂ aldehyde, C₁-C₁₂ ketone, C₁-C₁₂ ester, C₁-C₁₂ amide, C₁-C₁₂ carboxylic acid or halogen group, as an organic functional group, but it is not limited thereto. The organic binder may comprise at least one acrylic monomers having two or more functional groups, more specifically four functional groups.

In a specific embodiment of the present invention, curing promotors may be added in order to cure curable binders and they can be appropriately selected from conventional curing promotors that are used in the art. As the photocuring promotors, initiators of all photocuring mechanisms such as intermolecular hydrogen abstraction and intramolecular photo cleavage may be used. In particular, curing promotors such as benzophenone-based initiators or thioxantone-based initiators may be used for intermolecular hydrogen abstraction initiators, and α-hydroxy ketone-based initiators, α-amino ketone-based initiators, phenyl glyoxylate-based initiators, acyl phosphine oxide-based initiators, benzyl dimethyl ketal initiators where the molecules themselves absorb UV energy to form radicals may be used for intramolecular photo cleavage initiators, without any problems in compatability. Further, examples of thermocuring promotors to allow thermal curing at a rather low temperature include, but not limited to, epoxy-based resins, thermocuring acrylate-based resins, isocyanate-based resins and phenol-based resins. In addition, it is possible to use two different curing promotors together. Therefore, heat, ultraviolet light or both may be used in the curing step, depending on the curing promotors being used.

In another embodiment of the present invention, graphene may be present in a coating solution in an amount ranging from 0.005 to 99.999 parts by weight, specifically from 10 to 80 parts by weight, most specifically from 20 to 60 parts by weight, based on 100 parts by weight of the curable binder.

The present invention is further described and illustrated in the Examples provided below. However, it should be noted that the following Examples are presented only for illustrative purposes and are not intended to limit the scope of the present invention.

### Example 1

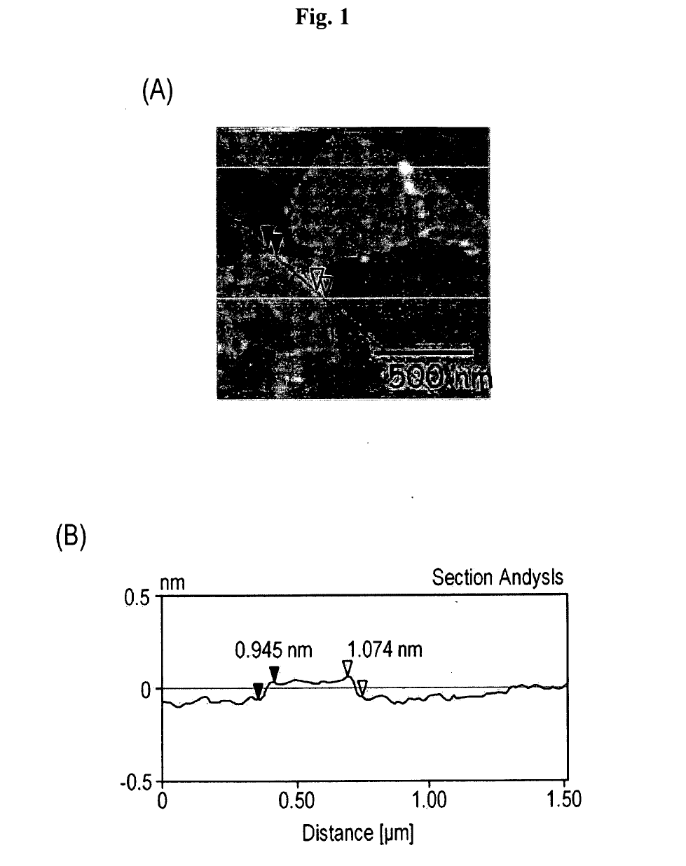

A coating solution where graphene obtained from graphite by chemical process was mixed with a polymer binder was prepared. Specifically, graphene oxide was prepared by the Hummers process where graphite was oxidized with strong oxidizing agents (H₂SO₄ and KMnO₄), followed by subjecting the prepared graphene oxide to reduction using a reducing agent (N₂H₄) to obtain graphene. The obtained graphene formed a very stable dispersed phase, and had a structure where single-layer or multi-layer graphenes were laminated, and the graphene sheet had the dimension of 1 nm in thickness and 500 nm in length, as shown in FIG. 1. Further, for the preparation of the silicone-based binder, 12.24 g (0.069 mol) of methyltriethoxysilane was added dropwise to a solution where 13 g of tetrahydrofuran (THF) and 12 g of distilled water were mixed, 6.6 g of 0.365 mol % hydrochloric acid diluted in distilled water was added thereto as a catalyst and subjected to a reaction at 25° C. for 24 hours, and then the solvents were completely distilled off under a reduced pressure to obtain a silicone-based binder having a molecular weight of 7,000 g/mol. 100 parts by weight of the obtained graphene and 30 parts by weight of the obtained silicone-based binder were mixed together to obtain a dispersion, followed by subjecting the dispersion to spin coating to obtain a coated film having a thickness of 70 nm. The coated film thus obtained was thermally cured at 120° C. for 1 hour to obtain a cured film. The cured film had a permeability of 92% and a surface resistivity of 8.0×10⁶Ω/□.

### Example 2

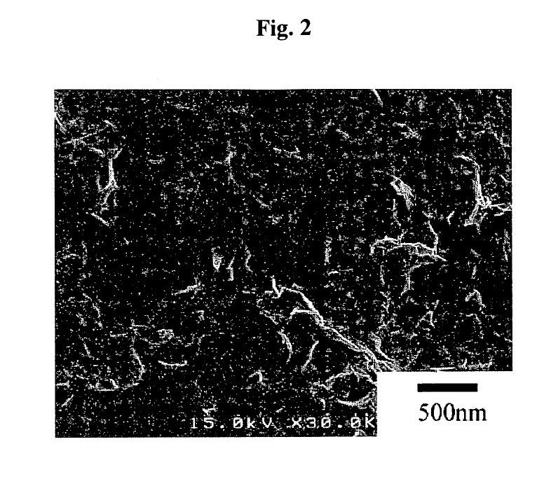

Graphite was stirred while applying ultrasonication for 3 hours in a supercritical CO₂ process at 100° C. and 100 bar, and then sprayed into the solvent under ultrasonic treatment by using rapid expansion supercritical solid (RESS) process to obtain a graphene solution. The obtained graphene had a structure of single-layer graphene or few-layer stacked graphene. 17.12 g (0.069 mol) of methacryloyloxypropyltrimethoxysilane was added dropwise to the aqueous solution where 13 g of tetrahydrofuran (THF) and 12 g of distilled water were mixed, 6.6 g of 0.365 mol % hydrochloric acid diluted in distilled water was added thereto as a catalyst and subjected to a reaction at 25° C. for 24 hours, and then the solvents were completely distilled off under reduced pressure to obtain a acrylic binder having a molecular weight of 8,000 g/mol. 100 parts by weight of the obtained graphene and 40 parts by weight of the polymer binder were mixed to obtain a mixed dispersion. The obtained dispersion was formed into a coated film having a thickness of 110 nm by a spray coating process. As shown in FIG. 2, the graphene sheet was uniformly deposited on the polycarbonate (PC) film via the spray coating process. Thereafter, based on the total weight, 5% by weight of Irgacure-184 was mixed therewith as a photoinitiator, and exposed to all wavelength region of ultraviolet light of 400 mW/cm² for 10 seconds to obtain a cured coating film. The cured coating film thus obtained had a permeability of 82% and a surface resistivity of 5.0×10⁴Ω/□.

### Example 3

Dispersion was obtained by using 100 parts by weight of graphene prepared in the same manner as described in Example 1, 50 parts by weight of bifunctional bisphenol A-ethylene glycol diacrylate (R-551, Nippon Chemical Industrial) and tetrafunctional dipentaerythritol hexacrylate (DPHA), and 2 parts by weight of Irgacure-184 as a photoinitiator. The obtained dispersion was formed into a coated film having a thickness of 150 nm by a spin coating process, and exposed to all wavelength region of ultraviolet light of 400 mW/cm² for 10 seconds to obtain a cured coating film. The cured coating film had a permeability of 75% and a surface resistivity of 1.0×10⁴Ω/□.

TABLE 1
Transparency and surface resistivity of the antistatic film

| | thickness | permeability (%) | surface resistivity |
|---|---|---|---|
| | (nm) | (wavelength 550 nm) | (Ω/□) |
| Example 1 | 70 | 92 | 8.0 × 10⁶ |
| Example 2 | 110 | 82 | 5.0 × 10⁴ |
| Example 3 | 150 | 75 | 1.0 × 10⁴ |

### INDUSTRIAL APPLICABILITY

According to the present invention, transparent or semitransparent antistatic films having excellent permeability, abrasion resistance and scratch resistance, chemical stability, dimensional stability can be prepared. Further, these films have superior adhesion to substrates and applicability, and thus may be advantageously applied to both rigid substrates and flexible substrates.

1. An antistatic film comprising:
conductive particles comprising single-layer or multi-layer graphene; and
a binder.

2. The antistatic film of claim 1, wherein the conductive particles are graphenes that are laminated.

3. The antistatic film of claim 1, wherein the ratio of oxygen atoms in the graphene molecule is 30% by weight or less.

4. The antistatic film of claim 1, wherein the conductive particles comprise single-layer to 30-layer or less graphene.

5. The antistatic film of claim 1, wherein the antistatic film has a surface resistivity ranging from 10² to 10¹³Ω/□.

6. The antistatic film of claim 1, wherein the antistatic film has a thickness ranging from 0.003 μm to 1000 μm.

7. The antistatic film of claim 1, wherein the antistatic film has a transparency ranging from 30% to 99.9% at a wavelength of 550 nm.

8. A method for preparing an antistatic film comprising:
dispersing graphene in a solvent to obtain a graphene dispersion;
dissolving a curable binder in a solvent to obtain a binder solution;
mixing the graphene dispersion and the binder solution to obtain a coating solution;
applying the coating solution to a substrate and drying the solution to form a coated film; and
curing the coated film.

9. The method of claim 8, wherein the curable binder is a thermocurable or photocurable binder.

10. The method of claim 9, wherein the curable binder is a silicone-based binder or an organic binder.

11. The method of claim 10, wherein the silicone-based binder is an alkoxy silane monomer having a pendant functional group, that is represented by formula 1, formula 2 or formula 3 below; or a silicone-based binder having a number average molecular weight ranging from 300 to 3,000,000 g/mol that is prepared from said silane monomer by using an acid catalyst or an alkali catalyst. 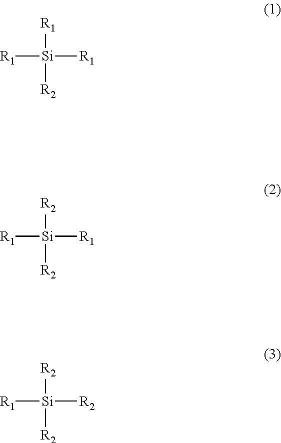
wherein
R₁ is an alkoxy group; and
R₂ is independently selected from organic functional groups consisting of C₁-C₁₂ alkyl, C₁-C₁₂ aryl, C₁-C₁₂ vinyl, C₁-C₁₂ amine, C₁-C₁₂ acryl, C₁-C₁₂ alkylhalogen, C₁-C₁₂ aldehyde, C₁-C₁₂ ketone, C₁-C₁₂ ester, C₁-C₁₂ amide, C₁-C₁₂ carboxylic acid and halogen group.

12. The method of claim 10, wherein the organic binder is a polymer having a number average molecular weight of 100 to 10,000,000 g/mol that comprises C₁-C₁₂ alkyl, C₁-C₁₂ aryl, C₁-C₁₂ vinyl, C₁-C₁₂ amine, C₁-C₁₂ acryl, C₁-C₁₂ alkylhalogen, C₁-C₁₂ aldehyde, C₁-C₁₂ ketone, C₁-C₁₂ ester, C₁-C₁₂ amide, C₁-C₁₂ carboxylic acid or halogen group, as an organic functional group.

13. The method of claim 10, wherein the organic binder comprises at least one acrylic monomer having two or more functional groups.

14. The method of claim 13, wherein the organic binder further comprises at least one acrylic monomer having four functional groups.

15. The method of claim 10, wherein the content of graphene is from 0.005 to 99.999 parts by weight, based on 100 parts by weight of the curable binder.

16. The method of claim 8, wherein the solvent is independently one or more selected from the group consisting of methyl alcohol, ethyl alcohol, isopropyl alcohol, butyl alcohol, acetone, methyl ethyl ketone, ethylene glycol, tetrahydrofuran, dimethylformamide, dimethylacetamide, N-methyl-2-pyrrolidone, hexane, cyclohexanone, cyclohexane, toluene, xylene, chloroform, methyl isobutyl ketone, methylene chloride, distilled water, dichlorobenzene, dimethylbenzene, trimethylbenzene, pyridine, triethylamine, methylnaphthalene, nitromethane, acrylonitrile, octadecylamine, aniline, dimethyl sulfoxide, benzyl alcohol, acetonitrile and dioxane.

17. The method of claim 8, wherein the substrate is one or more selected from the group consisting of glass, silicone wafer, ceramic and plastic.

18. The method of claim 8, wherein applying the coating solution is carried out by one or more method selected from the group consisting of spray coating, spin coating, dip coating, screen coating, inkjet coating, gravure coating, knife coating, kiss coating, stamping and imprint.

19. The method of claim 9, wherein heat, ultraviolet light or both are used when curing the coated film.
